(19) United States
(12) Patent Application Publication
(10) Pub. No.: US 2003/0088574 A1
(43) Pub. Date: May 8, 2003

(54) Method and machine for validating an identifier as unique

(76) Inventors: Andrew Edward White, Matraville (AU); Aidan Michael Williams, Chifley (AU); John Thomas Judge, Coogee (AU); Kwan-Wu Chin, Dluwich Hill (AU)

Correspondence Address: MOTOROLA, INC., 1303 EAST ALGONQUIN ROAD, IL01/3RD, SCHAUMBURG, IL, 60196

(21) Appl. No.: 10/053,466

(22) Filed: Nov. 7, 2001

(51) Int. Cl. G06F 7/00

(52) U.S. Cl. 707/102

(57) ABSTRACT

A method (200) and machine for validating that an identifier is unique within an ad-hoc network (100) of machines. The method comprises obtaining the identifier (220) and then sending a claim request for the identifier to machines in the network (100). Thereafter a step validating the identifier as unique is effected only if an invalidation message is not received within a predefined time period. The invalidation message is indicative of the identifier already being allocated to one of the machines in the network (100).

### FIELD OF THE INVENTION

This invention relates to validating an identifier as unique to a network. The invention is particularly useful for, but not necessarily limited to, validating identifiers for ad-hoc multi-link networks.

### BACKGROUND ART

In a network of machines, a designated machine can be used to generate unique identifiers for applications such as machine address allocations, random number seeds for each machine or for any other application that requires a unique value assigned to an object for a period of time. Every time an application requires a unique identifier, a claim request is provided and sent to the designated machine that allocates and sends the unique identifier to the requesting machine. The use of a designated machine for generation unique identifiers may cause unacceptable delays and is not suitable for networks whose structure does not need to be known, or is not known, at the time a claim request is provided.

In U.S. Pat. No. 5,117,351 there is described a method for generating unique identifiers by concatenating an obtained current time with a random number sequence. This method provides identifiers based on a presumption that it is highly unlikely that two identical identifiers can be generated from concatenations of random numbers and instances of time. However, this method provides identifiers comprising relatively large numbers of bits in order to minimize the likelihood of two identifiers being identical.

Claim-collide is another method for identifier allocation and validation, especially in ad-hoc or zero-configuration environments where a centralized mechanism is not used. The claim-collide device wishing to allocate an identifier chooses a suitable identifier—often randomly, but other algorithms exist—then validates it by attempting to use it on the network. If no other device complains of a conflict, the device assumes the identifier is available for it to use.

Current claim-collide methods rely on an existing communications mechanism that can propagate the claim throughout the applicable space. However, claim-collide methods are not used to allocate or validate identifiers in a multi-link environment of unknown structure.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for validating that an identifier is unique within an ad-hoc network of machines, said identifier being associated with an application for execution on one or more of the machines, the method comprising the steps of:

obtaining said identifier;

sending a claim request for said identifier to at least one machine in said network of machines; and

validating said identifier as unique to said application if an invalidation message is not received within a predefined time period, said invalidation message being indicative of said identifier being allocated to one of said machines.

According to another aspect of the invention there is provided a method for validating that an identifier is unique within an ad-hoc network of machines, said identifier being associated with an application for execution on one or more of the machines, the method comprising the steps of:

obtaining said identifier;

sending a claim request for said identifier from a claim requesting machine, that is one of said machines, to at least one other machine in said network of machines; and

validating said identifier as unique to said application if said requesting machine does not receive an invalidation message within a predefined time period, said invalidation message being indicative of said identifier being allocated to one of said machines.

Preferably, said method may be further characterized by said network being a multi-link network.

Suitably, the method may be further characterized by the number of operative machines on the network being unknown.

Preferably, the step of sending may be repeated at least once within said predefined time period.

Preferably, said identifier may be validated as unique for a pre-defined duration.

Suitably, the step of sending may be characterized by at least one of said machines receiving said claim request and thereafter propagating said claim request to at least one other of said machines.

Preferably, said claim request may be provided in a claim requesting message that includes said identifier and information identifying said application.

Suitably, said validating step may be further characterized by one of said machines, operating as a receiving machine, providing said invalidation message if upon receipt of said claim request the receiving machine has a prior claim to said identifier.

Preferably, said validating step may be further characterized by said invalidation message being routed to said claim requesting machine by use of network addresses.

Preferably, during said sending at least one of said machines may operate both as a receiving machine that receives said claim request and thereafter operates as a propagating machine thereby sending said invalidation message to at least one other of said machines.

According to another aspect of the invention there is provided a claim requesting machine for operation in an ad-hoc network of machines, wherein in use the claim requesting machine effects the steps of:

obtaining an identifier for an application associated with said claim requesting machine;

sending a claim request for to at least one other machine in said network of machines; and

validating said identifier as unique to said application if said requesting machine does not receive an invalidation message within a predefined time period, said invalidation message being indicative of said identifier being allocated to one of said machines.

The claim requesting machine may in use effect any or all of the above method steps. Suitably, the claim requesting machine may have any or all of the above method characteristics.

### BRIEF DESCRIPTION OF THE DRAWINGS

In order that the invention may be readily understood and put into practical affect, reference will now be made to preferred embodiments as illustrated with reference to the accompanying drawings in which:

FIG. 1 illustrates a schematic block diagram for one example of a multi-link ad-hoc network of machines in accordance with the invention;

FIG. 2 is a first embodiment of a flow diagram illustrating a method for validating that an identifier is unique within the multi-link ad-hoc network of machines of FIG. 1;

FIG. 3 illustrates hop-by-hop flooding of a claim request for the multi-link ad-hoc network of machines of FIG. 1;

FIG. 4 illustrates routing a claim invalidation message of a claim request to a requesting machine in the multi-link ad-hoc network of machines of FIG. 1; and

FIG. 5 is a second embodiment of a flow diagram illustrating a method for validating that an identifier is unique within the multi-link ad-hoc network of machines of FIG. 1.

### DETAILED DESCRIPTION OF THE PREFERRED EMBODIMENTS OF THE INVENTION

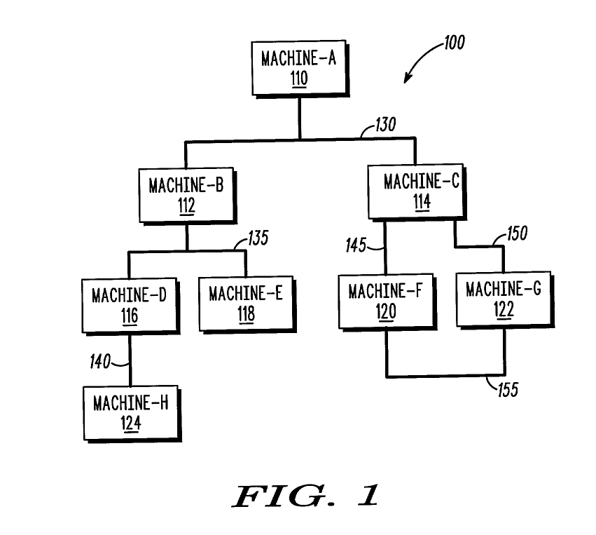

With reference to FIG. 1 there is illustrated an example of a multi-link ad-hoc network 100 of machines. It should be noted that in the network 100 there may be other machines that are not shown because they are not participating machines that propagate and respond to claim messages that are described below. The network 100 comprises a machine-A 110 coupled by a common link 130 to a machine-B 112 and a machine-C 114. Machine-B 112 is coupled by a common link 135 to a machine-E 118 and a machine-D 116 which is also coupled to a machine-H 124 by a link 140. Machine-C 114 is coupled to a Machine-F 120 by a link 145 and a link 150 couples Machine-C 114 to a machine G 122. Finally, machine-F 120 and machine-G 122 are coupled by a link 155. As will be apparent to a person skilled in that art, the machines 110,112,114,116,118,120,122,124 can be conventional computers or any other devices with processing capabilities. Also, the links 130,135,140,145,150,155 can be any network linking medium such as Ethernet cables, wireless links or otherwise. It should be noted that the number of operative or operating machines in the ad-hoc network 100 may vary and may be typically unknown to any or all of the machines.

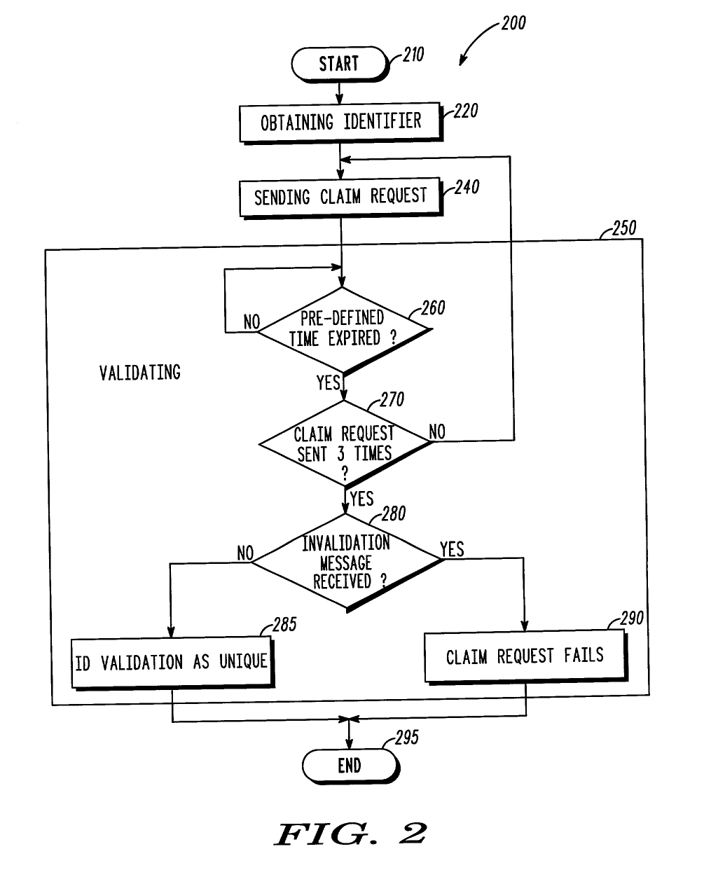

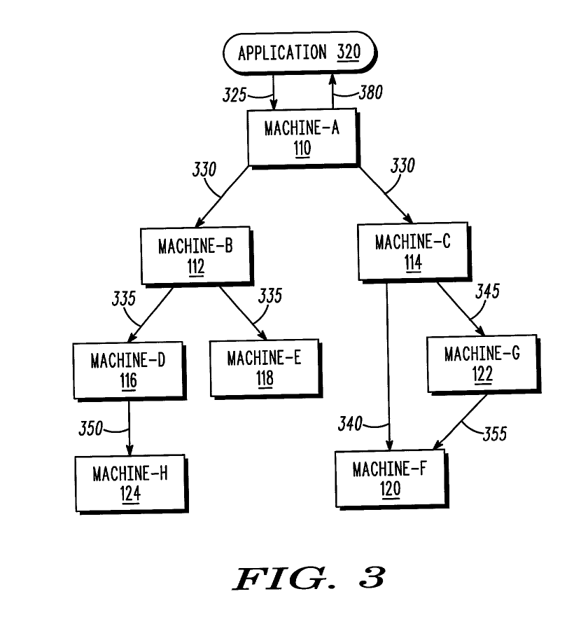

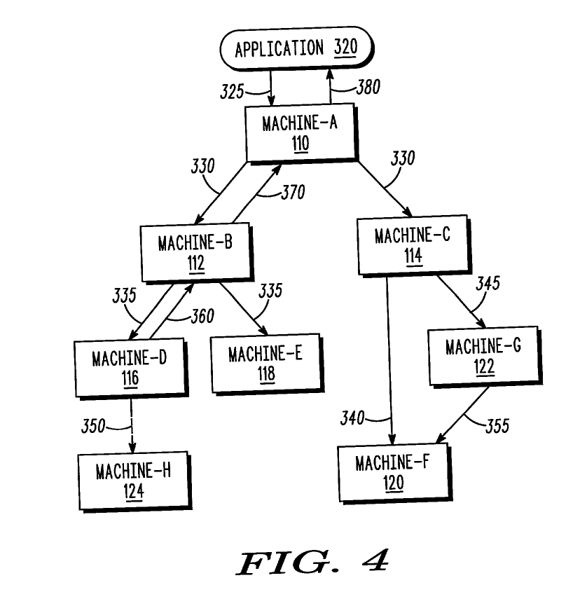

Referring to FIGS. 2 to 4 there is illustrated a method 200 for validating that an identifier ID is unique within the multi-link ad-hoc network 100 of machines. The method 200 is invoked at a start step 210 when an application 320, typically running on machine-A 110, requires a unique identifier UID and therefore provides a requesting signal 325. The unique identifier UID can, for example, be a number for a machine network address, a random number seed unique to one of the machines, a session identifier, a multicast address, a computer name, a dynamically chosen port or a communications channel. Thus in essence, unique identifier UID is something from a shared resource pool. At an obtaining identifier step 220 the machine-A 110 obtains the identifier ID, for example by use of a pseudo-random number generator, and sets a “sent claim request counter” to zero. In this specific example, however, the identifier ID is provided by the application 320. Hence, in this example the identifier ID is for the application 320 that is associated with machine-A 110. Thereafter, at a sending claim request step 240 the machine-A 110 (known as a claim requesting machine) sends a claim request for the identifier ID to the network 100 of machines.

The claim request is sent using hop-by-hop flooding in which the claim request is first sent to machine-B 112 and Machine-C 114 by a claim request message 330 along the common link 130. In the example network 100 illustrated, machine-B 12 and machine-C 114 operate as receiving machines for a claim request sent from machine-A 110. Machine-B 12 and machine-C 114 store the network address of machine-A 110 which can be obtained from a source address in the protocol of the network 100 as will be apparent to a person skilled in the art. The claim request is provided in a claim request message that preferably comprises: the identifier ID; a field for information identifying the application 320; a machine identifier field; a sequence number field; and a status field. The machine identifier field identifies which machine originally sent the claim request. The sequence number field is used for flood tracking in order to avoid infinite loops and the status field can include the required lifetime of the identifier ID.

When the claim message 330 is received by the machine-B 112 and machine-C 114, they determine if they have a prior claim to the identifier ID. In other words each of the machines 112,114 (operate as receiving machines for the method 200) checks if they have been allocated a number that is exactly the same as the number assigned to the identifier ID for the same purpose, which may or may not be the same for the same application 320. If there is a prior claim to the identifier ID, then the machine with the prior claim sends an invalidation message to machine-A 110 that is routed by the network address.

After receiving the claim request message 330 Machine-B 112 propagates the claim request by a claim message 335 along the common link 135 to machine-D 116 and Machine-E 118 which in the illustrated network 100 operate as receiving machines for the method 200, whereas machine-B 112 now operates as a propagating machine. Similarly, machine-C 114 now operates as a propagating machine and propagates the claim request by a claim request message 340 along the link 145 to machine-F 120 and by a claim message 345 along the link 150 to machine-G 122 (operating as a receiving machine for the purposes of the method 200). When machines 116, 118,120,122 receive their respective claim requesting messages, they check to determine if they have a prior claim to the identifier ID. if there is a prior claim to the identifier ID the machine with the prior claim responds as described above.

After receiving the claim request message 335, machine-D 116 propagates the claim request by a claim request message 350 along the link 140 to machine-H 124, which checks to determine if it has a prior claim to the identifier ID, and machine-G 114 propagates the claim request by a claim request message 355 to machine-F 120 along the link 155. However, since machine-F 120 has already received the claim request from machine-C 114 the claim request message 355 is ignored. From the above, it will be apparent that during hop-by-hop flooding the machines in the network 100 may operate both as receiving and propagating machines.

After the sending claim request step 240, the “sent claim request counter” is incremented and the machine-A 110 performs a validating step 250 in which machine-A 110 waits for a pre-defined time at a test step 260. A claim request sending test 270 is then effected to determine if the “sent claim request counter” indicates that the claim request has been sent three times. If the claim request has not been sent three times by machine-A 110 to the network 100, then the method 200 returns to the sending claim request step 240 and the sent claim request counter is increment.

When the claim request has been sent three times, an invalidation message received test step 280 is effected to determine if machine-A 110 has received a claim rejection for the claim request. A claim rejection is an invalidation message from one of the machines in the network 100 that is indicative of the identifier ID not being unique because it is allocated to another application running on one or more of the machines in the network 100. If no invalidation message was received by machine-A 110 then the identifier ID is determined as a unique identifier UID and validated as unique at an ID validation step 285, the application 320 is therefore informed, by a response message 380, that the identifier ID is a unique identifier UID. As will be apparent to a person skilled in the art, the identifier ID is typically validated as unique for a pre-defined time duration. After the ID validation step 285 is effected the method 200 ends at step 295.

If at the invalidation message received test step 280 it is determined that the machine-A 110 has received an invalidation message from one of the machines in the network 100, then the claim request fails at step 290 is effected and therefore the application 320 is informed, by the response message 380, that the identifier ID is not a unique identifier UID. For instance, upon machine-D 116 receiving the claim request, by the claim request message 335 along the link 135, then if the machine-D 116 determines that it is using the identifier ID and therefore has a prior claim thereto, an invalidation message 360 is routed to machine-B 112 along the link 135. The routing of the invalidation message to machine-B 112 is effected by the network address identifying which machine, in the network 100, sent the requesting message 335 to machine-H 124. As will be apparent to a person skilled in the art, there is no need for the machine-H 124 to propagate the claim request to machine-H 124 as the identifier ID has already been determined as not being unique.

When the machine-B 112 receives the invalidation message it routes an invalidation message 370 (by use of the network address) to machine-A 110 that in turn provides the response message 380 to the application 320 indicating that the identifier ID is allocated to another application in running on one or more of machines in the network 100. After the claim request fails step 290 is effected, the method 200 ends at step 295. The application 320 can again requests for a unique identifier UID and therefore provides the requesting signal 325.

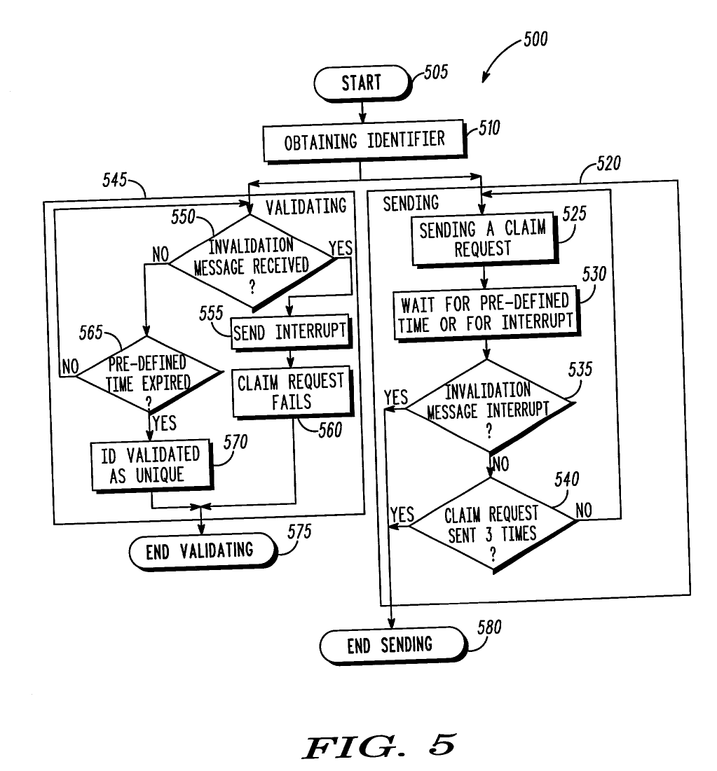

Referring to FIG. 5, there is illustrated a second embodiment of a method 500 for validating that an identifier is unique within the multi-link ad-hoc network 100 of machines. A start step 505 and obtaining identifier step 510 are identical to steps 220 and 240 of the method 200 and therefore to avoid repetition are not described again. After the obtaining step 510, two concurrent processes are invoked. The concurrent processes are a sending step 520 and a validating step 545. The sending step 520 firstly effects a sending a claim request step 525 that is identical to step 240 of the method 200. After the sending a claim request step 525 the method 500 waits at a waiting step 530 for a pre-defined time or for receipt of an interrupt from the concurrently running validating step 545. After completion of the waiting step 530, an invalidation interrupt test step 535 is effected to check if an invalidation interrupt was received at the waiting step 530. If an invalidation interrupt was received then the sending step 520 terminates at an end sending step 580. Alternatively, if no invalidation interrupt was received then a check is conducted at a test step 540 to determine if the claim request was sent three times by checking the “sent claim request counter”. In this regard steps 525, 530, 535 and 540 are effected three times, unless an invalidation interrupt is received. The sending step 520 then terminates at the end sending step 580.

The validating step 545 firstly determines if an invalidation message is received at a invalidation message received test step 550 that is identical to the invalidation message received test step 280 of the method 200. If no invalidation message was received at step 550 then a timer test step 565 is processed to determine if a pre-defined time has expired. If the pre-defined time has not expired then test step 550 is repeated and until either an invalidation message is received by machine-A 110 or the pre-defined time expires. If no invalidation message is received and the pre-defined time expires the identifier ID is determined as a unique identifier UID and is validated as unique at an ID validation step 570, the application 320 is therefore informed that the identifier ID is a unique identifier UID. After the ID validation step 570 is effected the validating step 545 ends at an end validating step 575.

If an invalidation message is received test step 550 then a send interrupt step 555 is effected thereby sending an interrupt to the concurrently running process that is effecting the sending step 520. A claim request fails step 560 is then processed, which is the same as the claim request fails step 290 of method 200, and the validating step 545 ends at the end validating step 575. Accordingly, the application 320 is informed that the identifier ID is not a unique identifier UID. The application 320, or another application, can then request for another unique identifier UID.

Advantageously, the present invention validates the identifier ID as a unique identifier UID in a multi-link network 100. The invention does not require a server and there is no need to know how the network 100 is configured or how routing is supported. Furthermore, the network 100 can be reconfigured on an ad-hoc basis and the invention advantageously can still validate unique identifiers UID.

The detailed description provides preferred exemplary embodiments only, and is not intended to limit the scope, applicability, or configuration of the invention. Rather, the detailed description of the preferred exemplary embodiments provide those skilled in the art with an enabling description for implementing preferred exemplary embodiments of the invention. It should be understood that various changes may be made in the function and arrangement of elements without departing from the spirit and scope of the invention as set forth in the appended claims. For instance, any of the machines in the network 100 can receive a requesting signal 325 from an application and thereafter effect the steps of methods 200 or 500.

We claim:

1. A method for validating that an identifier is unique within an ad-hoc network of machines, said identifier being associated with an application for execution on one or more of the machines, the method comprising the steps of:
obtaining said identifier;
sending a claim request for said identifier to at least one machine in said network of machines; and
validating said identifier as unique to said application if an invalidation message is not received within a predefined time period, said invalidation message being indicative of said identifier being allocated to one of said machines.

2. A method as claimed in claim 1, wherein said network is a multi-link network.

3. A method as claimed in claim 1, further characterized by a number of operative machines on the network being unknown.

4. A method as claimed in claim further characterized by a number of operative machines on the network being unknown.

5. A method as claimed in claim 2, wherein the step of sending is repeated at least once within said predefined time period.

6. A method as claimed in claim 2, further characterized by said identifier being validated as unique for a pre-defined duration.

7. A method as claimed in claim 2, wherein the step of sending is characterized by at least one of said machines receiving said claim request and thereafter propagating said claim request to at least one other of said machines.

8. A method as claimed in claim 2, wherein said claim request is provided in a claim requesting message that includes said identifier and information identifying said application.

9. A method as claimed in claim 2, wherein said validating step is further characterized by one of said machines, operating as a receiving machine, providing said invalidation message if upon receipt of said claim request the receiving machine has a prior claim to said identifier.

10. A method as claimed in claim 9, wherein said validating step is further characterized by said invalidation message being routed to said claim requesting machine by use of network addresses.

11. A method as claimed in claim 2, wherein during said sending at least one of said machines operates both as a receiving machine that receives said claim request and thereafter operates as a propagating machine thereby sending said invalidation message to at least one other of said machines.

12. A method for validating that an identifier is unique within an ad-hoc network of machines, said identifier being associated with an application for execution on one or more of the machines, the method comprising the steps of:
obtaining said identifier;
sending a claim request for said identifier from a claim requesting machine, that is one of said machines, to at least one other machine in said network of machines; and
validating said identifier as unique to said application if said requesting machine does not receive an invalidation message within a predefined time period, said invalidation message being indicative of said identifier being allocated to one of said machines.

13. A method as claimed in claim 12, wherein said network is a multi-link network.

14. A method as claimed in claim 12, further characterized by a number of operative machines on the network being unknown.

15. A method as claimed in claim 13, further characterized by a number of operative machines on the network being unknown.

16. A method as claimed in claim 13, wherein the step of sending is repeated at least once within said predefined time period.

17. A method as claimed in claim 13, further characterized by said identifier being validated as unique for a pre-defined duration.

18. A method as claimed in claim 13, wherein the step of sending is characterized by at least one of said machines receiving said claim request and thereafter propagating said claim request to at least one other of said machines.

19. A method as claimed in claim 13, wherein said claim request is provided in a claim requesting message that includes said identifier and information identifying said application.

20. A method as claimed in claim 13, wherein said validating step is further characterized by one of said machines, operating as a receiving machine, providing said invalidation message if upon receipt of said claim request the receiving machine has a prior claim to said identifier.

21. A method as claimed in claim 20, wherein said validating step is further characterized by said invalidation message being routed to said claim requesting machine by use of network addresses.

22. A method as claimed in claim 13, wherein during said sending at least one of said machines operates both as a receiving machine that receives said claim request and thereafter operates as a propagating machine thereby sending said invalidation message to at least one other of said machines.

23. A claim requesting machine for operation in an ad-hoc network of machines, wherein in use the claim requesting machine effects the steps of:
obtaining an identifier for an application associated with said claim requesting machine;
sending a claim request for to at least one other machine in said network of machines; and
validating said identifier as unique to said application if said requesting machine does not receive an invalidation message within a predefined time period, said invalidation message being indicative of said identifier being allocated to one of said machines.

24. A claim requesting machine as claimed in claim 23, wherein said network is a multi-link network.

25. A method as claimed in claim 23, further characterized by a number of operative machines on the network being unknown.

26. A method as claimed in claim 24, further characterized by a number of operative machines on the network being unknown.
